(19) United States
(12) Patent Application Publication
(10) Pub. No.: US 2012/0070211 A1
(43) Pub. Date: Mar. 22, 2012

(54) DOCUMENT TRANSPORTING DEVICE AND IMAGE FORMING APPARATUS

(76) Inventor: Hideo Koiwai, Kanagawa (JP)

(21) Appl. No.: 13/025,632

(22) Filed: Feb. 11, 2011

(30) Foreign Application Priority Data
Sep. 17, 2010 (JP) 2010-209767

(51) Int. Cl. G03G 15/00; B65H 5/06

(52) U.S. Cl. 399/361; 271/264

(57) ABSTRACT

A document transporting device includes: a document-accommodating-section; a transporting-mechanism; a feeding-member that feeds a document to the transporting-mechanism by rotating; a rotation-shaft that is driven to rotate and rotatably supports the feeding-member; an engaged-portion formed at an end portion of the feeding-member; a transmitting member that, by moving in a rotation-shaft-axial-direction, can be located at a transmitting-position where rotation of the rotation-shaft is transmitted to the feeding-member by an engaging-portion of the transmitting member being engaged with the engaged-portion, and at a releasing-position where engagement therebetween is released; a moving member provided on the rotation-shaft, that, upon relative rotating of the rotation-shaft and the transmitting member, moves the transmitting member to the transmitting-position and transmits the rotation of the rotation-shaft to the transmitting member; and a resistor that contacts with an outer peripheral surface of the transmitting member and provides a resistance in a rotational-direction to the transmitting member.

### CROSS-REFERENCE TO RELATED APPLICATION

This application is based on and claims priority under 35 USC 119 from Japanese Patent Application No. 2010-209767 filed Sep. 17, 2010.

### BACKGROUND

### Technical Field

The invention relates to a document transporting device and an image forming apparatus.

### SUMMARY

An aspect of the present invention is a document transporting device including: a document accommodating section in which a document is accommodated; a transporting mechanism that transports the document accommodated in the document accommodating section along a transporting path; a feeding member that contacts with the document accommodated in the document accommodating section and feeds the document to the transporting mechanism by rotating; a rotation shaft that is driven to rotate and that rotatably supports the feeding member; an engaged portion that is formed at an end portion of the feeding member; a transmitting member that, by moving in an axial direction of the rotation shaft, can be located at a transmitting position where rotation of the rotation shaft is transmitted to the feeding member by an engaging portion of the transmitting member being engaged with the engaged portion, and at a releasing position where engagement between the engaged portion and the engaging portion is released; a moving member provided on the rotation shaft, that, upon relative rotating of the rotation shaft and the transmitting member, moves the transmitting member to the transmitting position and transmits the rotation of the rotation shaft to the transmitting member; and a resistor that contacts with an outer peripheral surface of the transmitting member and provides a resistance in a rotational direction to the transmitting member.

### BRIEF DESCRIPTION OF THE DRAWINGS

Exemplary embodiments of the invention will be described in detail with reference to the following figures, wherein:

FIG. 1 is a schematic side view showing a structure of an image forming apparatus;

FIG. 2 is a schematic front view showing the structure of the image forming apparatus;

FIG. 3 is a schematic perspective view showing a document transporting section;

FIG. 4 is a schematic perspective view showing a structure of a pickup roll side of a transporting mechanism in the document transporting section;

FIG. 5 is a schematic perspective view showing a structure of the pickup roll and a feeding roll of the transporting mechanism in the document transporting section;

FIG. 6 is a schematic perspective view showing a drive transmitting system of the pickup roll and the feeding roll;

FIG. 7 is a schematic perspective view showing a mylar provided in the pickup roll and the feeding roll;

FIG. 8 is a schematic perspective view showing the mylar provided in the pickup roll and the feeding roll in an enlarged manner;

FIG. 9 is a schematic cross sectional view showing the mylar provided in the pickup roll and the feeding roll; and

FIGS. 10A and 10B are explanatory diagrams showing a movement of a transmitting member when the mylar is provided.

### DETAILED DESCRIPTION

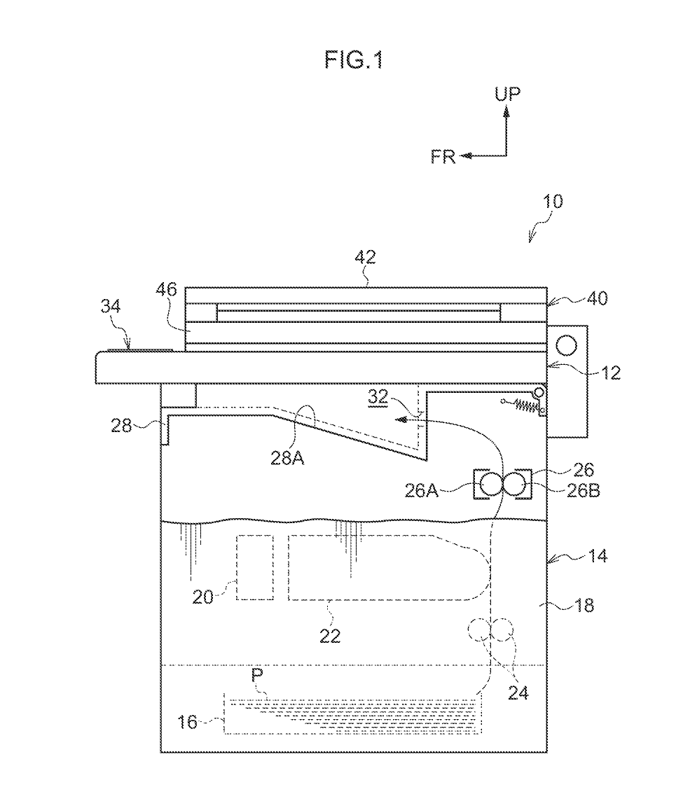

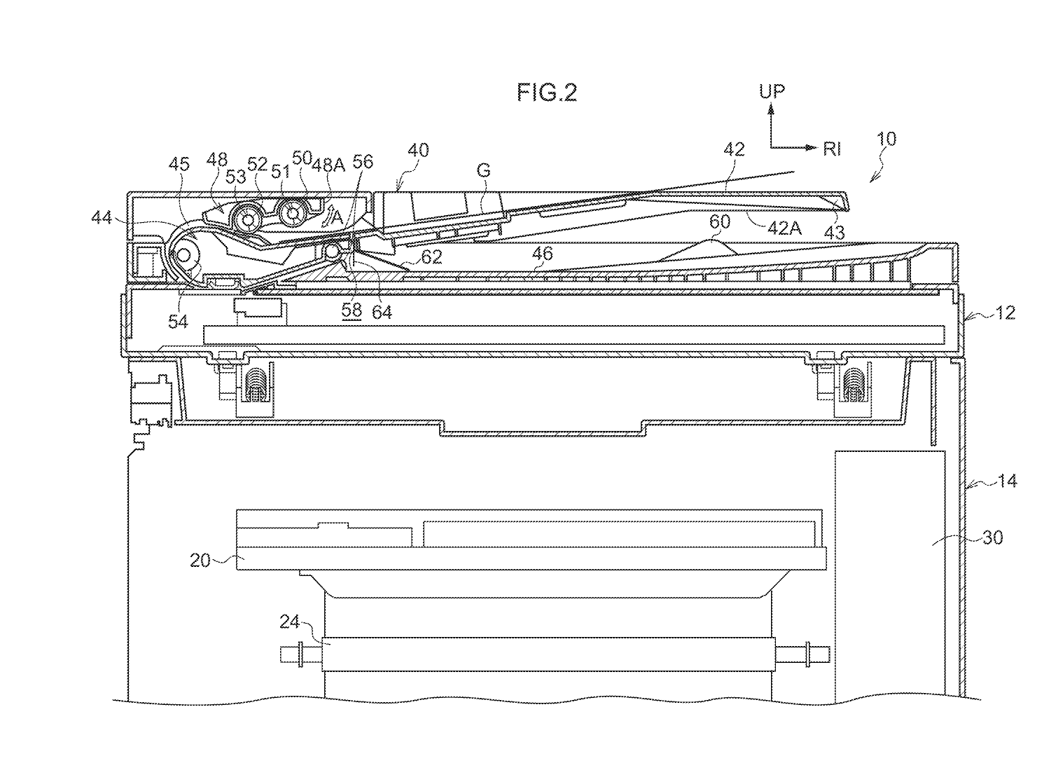

An exemplary embodiment according to the present invention will be described below in detail with reference to the drawings. In FIG. 1, the arrow UP denotes the upward direction of an image forming apparatus 10 and the arrow FR denotes a forward direction of the image forming apparatus 10. In FIG. 2, the arrow RI denotes the right direction of the image forming apparatus 10 which is a discharge direction of a document G (see FIG. 2). In the exemplary embodiment, a recording sheet P (see FIG. 1) is used as one example of a recording medium on which an image is formed.

As shown in FIGS. 1 and 2, the image forming apparatus 10 includes a document transporting section 40 as one example of a document transporting device that transports a document G, a document reading section 12 that reads image information of the document G, and a main body 14 arranged below the document reading section 12. The document transporting section 40 will be described below in detail.

The main body 14 is configured to form an image on the recording sheet P based on the image information read by the document reading section 12, and includes a sheet supplying tray 16 arranged at its lower portion, and an image forming section 18, arranged at the upper portion of the sheet supplying tray 16, that forms an image. The image forming section 18 includes an exposing device 20 and an image forming unit 22.

The exposing device 20 emits a light beam such that, based on the image information read by the document reading section 12, a light beam emitted from a light source (not shown in the drawings) is scanned (deflected) by a rotational polygon mirror and is reflected on plural optical components such as reflecting mirror. The light beam is guided to a corresponding photoreceptor drum.

The image forming unit 22 includes the photoreceptor drum (not shown in the drawings), a charging roll, a cleaner, a transfer roll, a developing device and the like, and the sheet supplying tray 16 is arranged below the image forming unit 22. A pair of registering rolls 24 that adjusts the position of a tip end portion of the recording sheet P is arranged the rear side and the upper side of the sheet supplying tray 16.

A fixing device 26 is arranged at the downstream side in the transporting direction of the recording sheet P with respect to the image forming unit 22. The fixing device 26 includes a heating roll 26A and a pressurizing roll 26B, and the fixing device 26 fixes a toner image transferred on the recording sheet P by heating and pressurizing the recording sheet P on the recording sheet P.

The upper portion of the image forming section 18, which is at the downstream side in the transporting direction of the recording sheet P with respect to the fixing device 26, is covered with an openable/closable cover member 28. The recording sheet P is discharged from a discharge port 32 provided at the downstream side in the transporting direction of the recording sheet P with respect to the fixing device 26 to an upper surface 28A of the cover member 28. The main body 14 is provided with a controlling section 30 that controls operations of the respective sections.

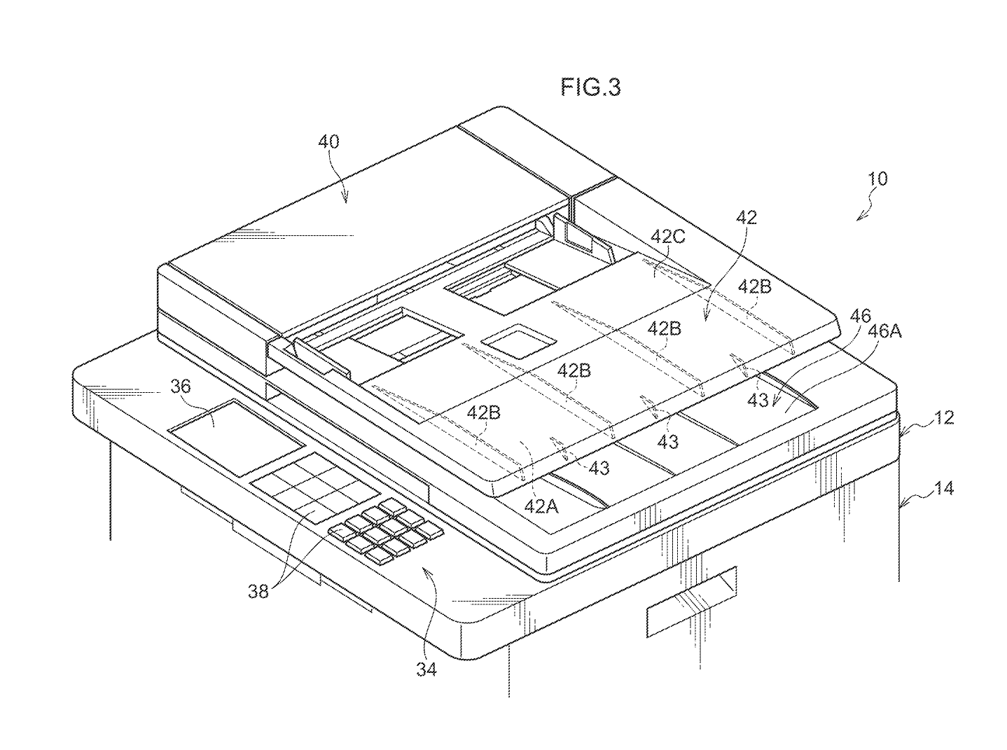

The document reading section 12 is arranged at the main body 14 at its upper portion. At the document reading section 12 at its front face, an operation panel unit 34 is provided. The operation panel unit 34 is provided with a display section 36 and an operating section 38 including numerical keys, a start button and the like, by which an operator inputs/performs reading of image information of the document G, copying instruction and the like, as detailed in FIG. 3.

The document transporting section 40 is provided at the document reading section 12 at its upper portion. The document transporting section 40 also serves as an opening/closing cover for the document reading section 12. As shown in FIGS. 2 and 3, the document transporting section 40 includes a document accommodating table 42, a pick up roll 50, a transporting mechanism 44 and a document discharge table 46. The document accommodating table 42 serves as one example of the document accommodating section in which the document G whose image information is to be read is accommodated (in a case of plural documents G, they are accommodated in stack manner). The pick up roll 50 serves as one example of a feeding member and picks up the documents G accommodated on the document accommodating table 42 one by one. The outer periphery portion of the pick up roll 50 is made of rubber. The transporting mechanism 44 that transports the document G delivered from the pick up roll 50 along a return-shaped transporting path 45. The document discharge table 46 serves as one example of the document discharge section, which is arranged below the document accommodating table 42 and to which the document G transported through the transporting path 45 is discharged.

In other words, the document accommodating table 42 and the document discharge table 46 are collectively arranged on one side of the document transporting section 40 (the right side in FIG. 2). Specifically, the document accommodating table 42 and the document discharge table 46 are arranged so as to be overlapped in the upper and lower (vertical) direction at one side of the document transporting section 40 (the right side in FIG. 2), and an interval in the upper and lower direction between the document accommodating table 42 and the document discharge table 46 is formed so as to be relatively narrow (to the extent such that about 20 plain sheets of document G may be discharged).

A part of an upper surface 42C of the document accommodating table 42 at the feeding direction downstream side is formed as a tilted surface which is a descending slope descending toward the feeding direction of the document G. A part of the upper surface 46A of the document discharge table 46 at the discharge direction downstream side is formed as a tilted surface which is an ascending slope ascending toward the discharge direction of the document G (see FIG. 2).

As shown in FIG. 2, the transporting mechanism 44 includes a feeding roll 52 whose outer periphery portion is made of rubber and which feeds the document G picked up by the pickup roll 50, a reversing roll 54 that returns (U-turns) the document G fed by the feeding roll 52 and reverses the front side and the back side of the document G, and a pair of discharging rolls 56 discharging the document G which is reversed the front side/the back side thereof by the reversing roll 54 onto the document discharge table 46.

Thus, the document G is placed on the document accommodating table 42 with the read surface on which the image information to be read is recorded being faced upward, is transported in the feeding direction by the pickup roll 50 and the feeding roll 52, and is reversed the front side/the back side by the transporting path 45 and the reversing roll 54, so the read surface of the document G is faced to the document reading section 12.

Then, when the image information recorded on the read surface is read by the document reading section 12, the document G is discharged by the pair of discharging rolls 56 from the discharge port 58, and is discharged (placed) onto the document discharge table 46 with the read surface being faced downward.
The pickup roll 50 and the feeding roll 52 will be described below in detail.

As shown in FIG. 2, at the discharge port 58, a mylar 62 as one example of the holding (pressing) member that holds down (presses) the document G discharged onto the document discharge table 46 from the above is provided (the mylar 62 also holds down the documents G from above when it is being discharged from the discharge port 58 so as to suppress flutteringly movement of the documents G). The mylar 62 is formed to be comb-shaped and its lower end (free end) contacts with the upper surface 46A of the document discharge table 46 when no document G is present.

At the upper surface 46A of the document discharge table 46, plural ribs 60 are provided (formed) in a protruding manner at a predetermined interval therebetween in the axial direction of the discharging roll 56 (in the longitudinal direction of the discharge port 58). The ribs 60 are configured such that the ribs 60 support a substantially intermediate portion of the document G discharged onto the upper surface 46A of the document discharge table 46 from below. The ability of accommodating the documents G discharged onto the document discharge table 46 can be enhanced by the ribs 60 and the mylar 62.

Plural electrical-neutralizing (erasing) brushes 64 which contact with the document G discharged from the discharge port 58 and are which electrical-neutralize (erase) the document G are provided between the comb-teeth of mylar 62. The document accommodating table 42 is provided with a sensing section (not shown in the drawings) that senses whether or not the document G is being accommodated. As the sensing section, a light-reflective optical sensor or the like, for example, is used, but a sensor having other configuration may be used.

As shown in FIG. 2, the lower surface 42A at the document G feeding direction upstream side (the document G discharge direction downstream side) relative to the tilted surface of the document accommodating table 42, which faces the document discharge table 46, is slightly bent toward the document discharge table 46, viewed from the axial direction of the discharging roll 56 (the longitudinal direction of the discharge port 58). As shown in FIG. 3, plural ribs 42B are arranged at a predetermined interval therebetween in the axial direction of the discharging roll 56 at the feeding direction upstream side of the lower surface 42A of the document accommodating table 42.

Ribs 43 whose length are shorter than the ribs 42B are arranged in the axial direction of the discharging roll 56 at an end portion of the lower surface 42A in the feeding direction upstream side, each rib 43 being disposed between the corresponding ribs 42B. Even if the width direction both end portions of the document G discharged from the discharge port 58 to the document discharge table 46 are curled upward, the discharge direction downstream side end portion of the document G is guided toward the upper surface 46A of the document discharge table 46 by the respective ribs 42B and 43.

The pickup roll 50 and the feeding roll 52 will be described below in more detail. As shown in FIGS. 2, 4 and 5, the pickup roll 50 and the feeding roll 52 are accommodated in a casing 48 while being rotatably supported in a state in which their rubber outer peripheral surfaces are exposed.

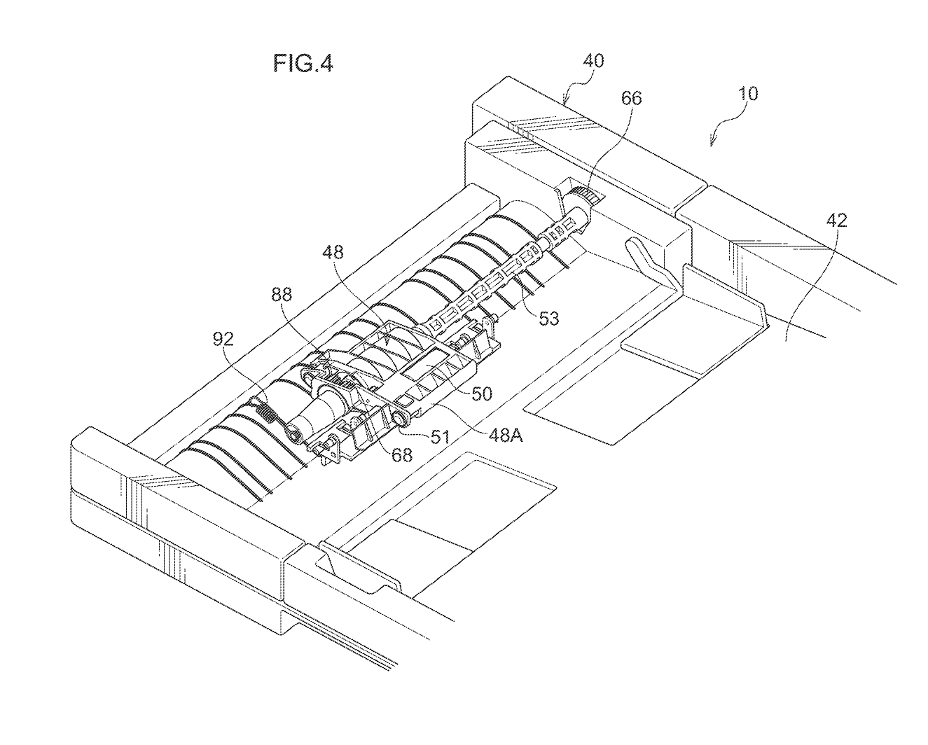

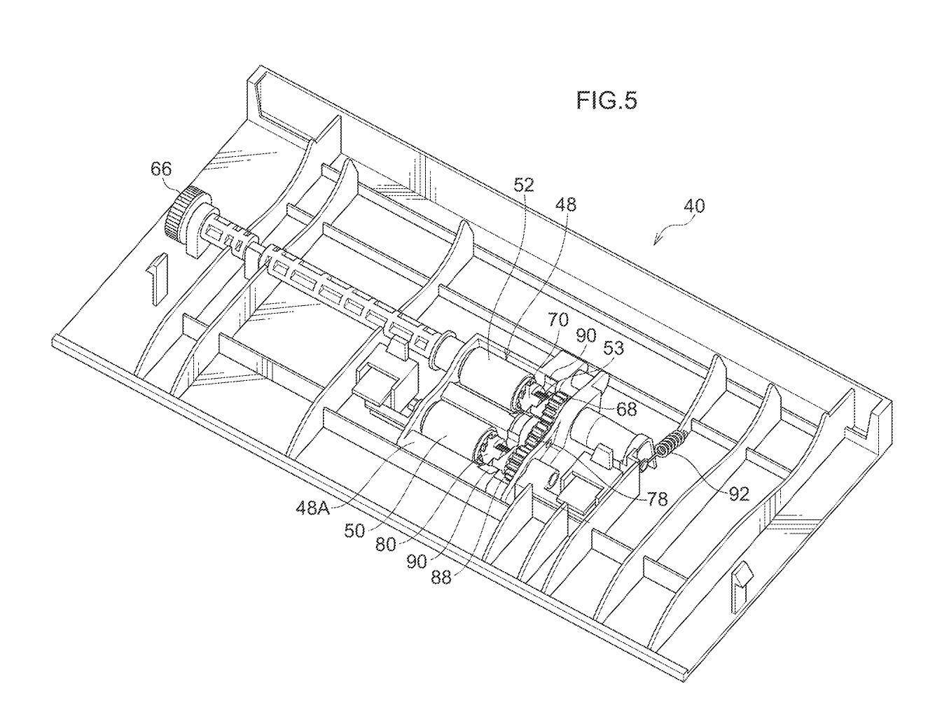

The feeding roll 52 is configured to be cylindrical, and a rotation shaft 53 is penetrated through the axial hole of the feeding roll 52 so that the feeding roll 52 is rotatably supported on the rotation shaft 53. A drive gear 66 (see FIGS. 4 and 5) which is rotated to drive by a drive source (not shown in the drawings) is fixed on one end portion of the rotation shaft 53 protruding from the casing 48.

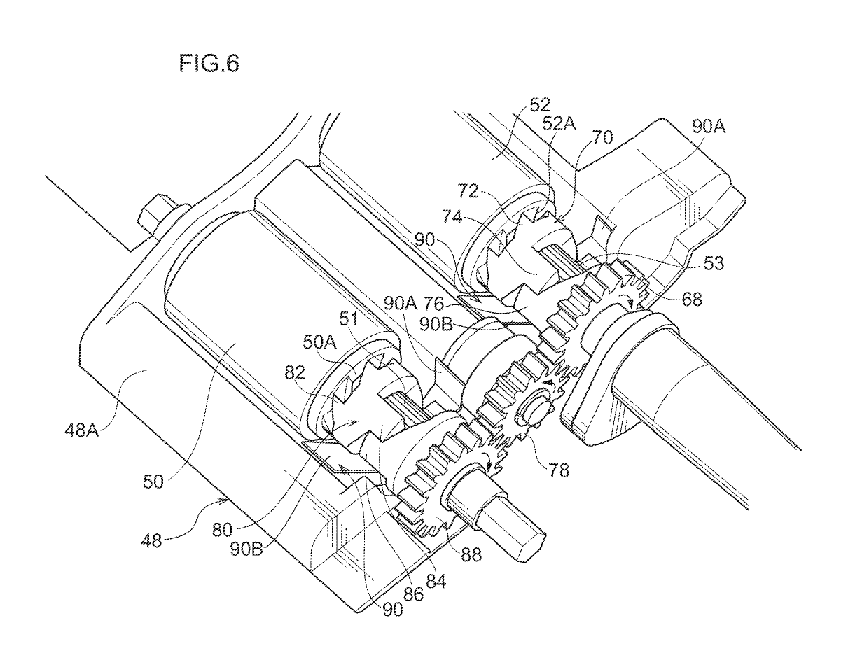

As shown in detail in FIGS. 6 to 8, a transmitting member 70 made of resin such as POM (poly-acetal), which is for transmitting a rotational drive force of the rotation shaft 53 to the feeding roll 52, is supported movably in the axial direction of the rotation shaft 53 at the side of the other end portion of the rotation shaft 53. In other words, the transmitting member 70 is configured to be cylindrical similar to the feeding roll 52, and the rotation shaft 53 is penetrated through the axial hole of the transmitting member 70 so that the transmitting member 70 is movably supported on the rotation shaft 53.

An engaging claw(s) 72 as one example of an engaging part that meshes (engages) with an engaged claw(s) 52A as one example of an engaged part formed on an end surface of the feeding roll 52 is formed on one end surface, which faces the end surface (end portion) of the feeding roll 52, of the transmitting member 70. The engaging claw 72 and the engaged claw 52A are formed as triangle claws protruding to be opposite to each other in the axial direction of the rotation shaft 53, and the engaging claws 72 and the engaged claws 52A are plural-formed along the respective peripheral directions such that they are coaxial with the rotation shaft 53.

A cam part 74 including a linear portion 74A which is along the axial direction of the rotation shaft 53 and a tilted portion 74B which is tilted relative to the axial direction is formed on the other end surface of the transmitting member 70. The cam part 74 is formed so as to engage with a convex part 76 as one example of a moving part which is integrally formed at the feeding roll 52 side of a transmitting gear 68 (which will be described below) fixed on the rotation shaft 53.

In other words, the convex part 76 is provided so as to protrude in the axial direction (toward the transmitting member 70 side) on the outer peripheral surface of the rotation shaft 53, and includes a linear portion 76A which is along the axial direction of the rotation shaft 53 and a tilted portion 76B which is tilted relative to the axial direction similar to the cam part 74.

Thus, when the convex part 76 rotates due to the rotation of the rotation shaft 53, the tilted portion 76B of the convex part 76 pushes an edge portion 74C in the linear portion 74A of the cam part 74 due to a relative rotation between the transmitting member 70 and the rotation shaft 53. Then, the edge portion 74C relatively moves along the tilted portion 76B of the convex part 76 so that the transmitting member 70 moves toward the feeding roll 52 in the axial direction of the rotation shaft 53. Then, the engaging claw 72 of the transmitting member 70 meshes with the engaged claw 52A of the feeding roll 52.

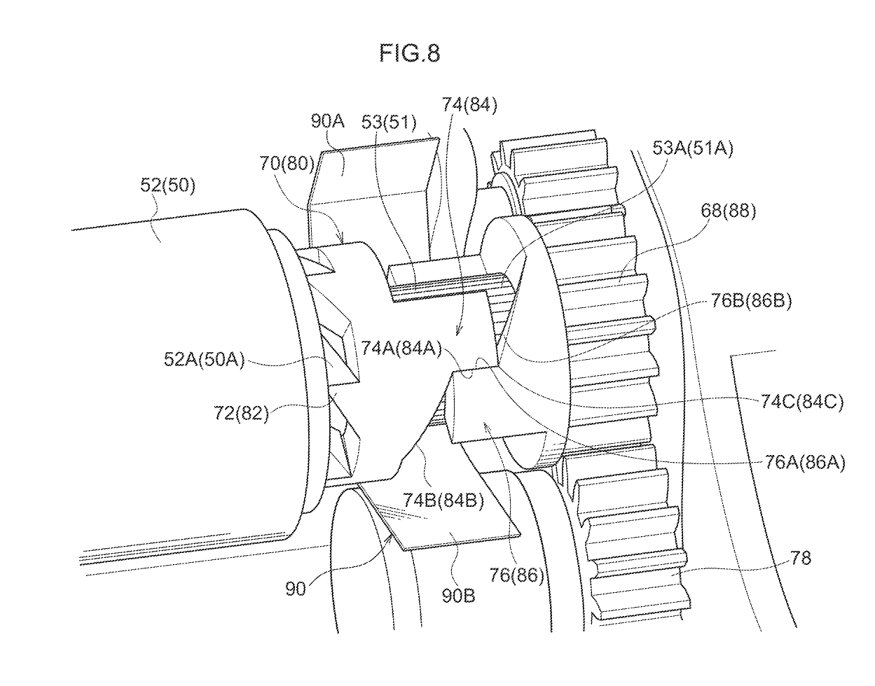

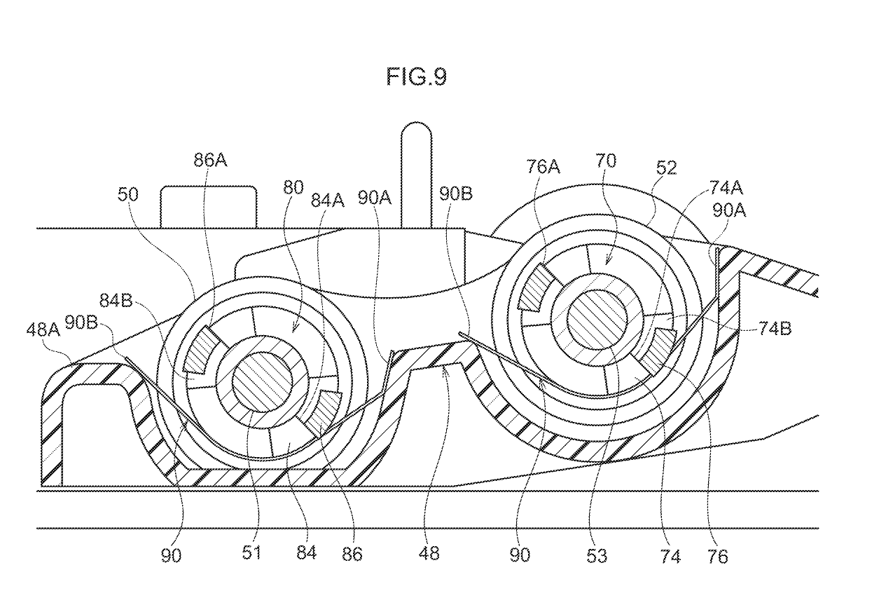

At this time, the linear portion 76A of the convex part 76 and the linear portion 74A of the cam part 74 are maintained in a mutually contacting state (see FIGS. 6 and 8). Thus, the rotational drive force of the rotation shaft 53 is transmitted to the feeding roll 52 via the transmitting member 70. In other words, the feeding roll 52 rotates integral with the rotation of the rotation shaft 53 with no relative rotation being present between the rotation shaft 53 and the feeding roll 52. It is desirable that two cam parts 74 and two convex parts 76 are formed at the same interval therebetween along the respective peripheral directions of the rotation shaft 53 (see FIG. 9).

As shown in FIG. 6, the resin made transmitting gear 68 fixed on the rotation shaft 53 meshes with an intermediate gear 78 rotatably supported in the casing 48, and the intermediate gear 78 meshes with a resin made transmitting gear 88 fixed on the rotations shaft 51 of the pickup roll 50. Thus, the rotational drive force of the rotations shaft 53 is transmitted to the rotation shaft 51 via the intermediate gear 78. The structure of the pickup roll 50 side is similar to that of the feeding roll 52 side.

That is, the pickup roll 50 is also configured to be cylindrical, and the rotation shaft 51 is penetrated through the axial hole of the pickup roll 50 so that the pickup roll 50 is rotatably supported on the rotation shaft 50. A transmitting member 80 made of resin such as POM (poly-acetal) that is for transmitting the rotational drive force of the rotation shaft 51 to the pickup roll 50 is supported movably in the axial direction of the rotation shaft 51 at the side of the transmitting gear 88 of the rotation shaft 51.

The transmitting member 80 is configured to be cylindrical similar to the transmitting member 70, and the rotation shaft 51 is penetrated through the axial hole of the transmitting member 80 so that the transmitting member 80 is movably supported on the rotation shaft 51. An engaging claw(s) 82 as one example of an engaging part that meshes with an engaged claw(s) 50A as one example of an engaged part formed at an end surface of the pickup roll 50 is formed on one end surface, which faces the end surface (end portion) of the pickup roll 50, of the transmitting member 80.

The engaging claw 82 and the engaged claw 50A are formed as triangle claws protruding to be opposite to each other in the axial direction of the rotation shaft 51, and the engaging claws 82 and the engaged claws 50A are plural-formed along the respective periphery directions, so as to be coaxial with the rotation shaft 51. A cam part 84 including a liner portion 84A which is along the axial direction of the rotation shaft 51 and a tilted portion 84B tilted relative to the axial direction is formed on the other end surface of the transmitting member 80 (the structure thereof is identical to the transmitting member 70 and thus reference numerals are in parenthesis in FIG. 8).

The cam part 84 engages with a convex part 86 as one example of a moving part integrally formed at the pickup roll 50 side of the transmitting gear 88 fixed on the rotation shaft 51. That is, the convex part 86 is provided to protrude in the axial direction (toward the transmitting member 80 side) on the outer peripheral surface of the rotation shaft 51, and includes a linear portion 86A which is along the axial direction of the rotation shaft 51 and a tilted portion 86B tilted relative to the axial direction similar to the cam part 84.

Thus, when the convex part 86 rotates due to the rotation of the rotation shaft 51, the tilted portion 86B of the convex part 86 pushes an edge portion 84C in the linear portion 84A of the cam part 84 due to the relative rotation between the transmitting member 80 and the rotation shaft 51. Then, the edge portion 84C relatively moves along the tilted portion 86B of the convex part 86 so that the transmitting member 80 moves toward the pickup roll 50 side along the axial direction of the rotation shaft 51. Then, the engaging claw 82 of the transmitting member 80 meshes with the engaged claw 50A of the pickup roll 50.

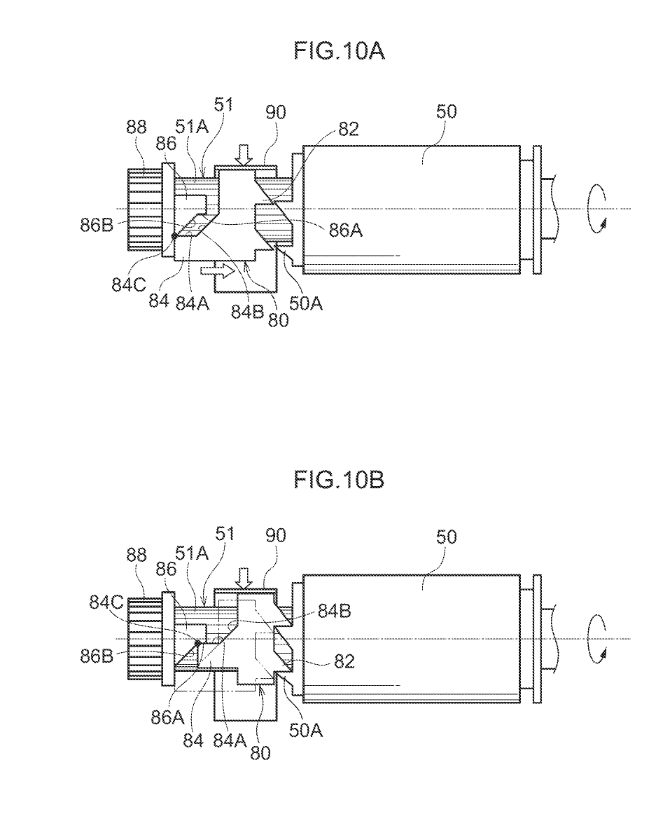

At this time, the linear portion 86A of the convex part 86 and the linear portion 84A of the cam part 84 are maintained in a mutually contacting state (see FIGS. 6 and 10). Thus, the rotational drive force of the rotation shaft 51 is transmitted to the pickup roll 50 via the transmitting member 80. In other words, the pickup roll 50 rotates integral with the rotation of the rotation shaft 51 with no relative rotation being present between the rotation shaft 51 and the pickup roll 50. It is desirable that two cam parts 84 and the two convex parts 86 are formed at the same interval therebetween along the respective peripheral directions of the rotation shaft 51, similar to the foregoing (see FIG. 9).

As shown in FIGS. 6 to 9, a mylar 90 as one example of a resistor that gives a rotational direction (peripheral direction) sliding resistance to the transmitting member 80 is provided between the outer peripheral surface of the transmitting member 80 and the inner surface of the casing 48 at the pickup roll 50 side. The mylar 90 is formed to have a film-shape made of resin material such as PET (polyethylene terephthalate), and its thickness is about 0.1 mm.

One end portion 90A (one end portion in the peripheral direction of the rotation shaft 51, that is, one end portion in a direction orthogonal to the axial direction of the rotation shaft 51) of the mylar 90 is attached to an opening verge (edge) portion of the casing 48 at the rotational direction upstream side of the rotation shaft 51 by bonding (affixing), and the other end portion 90B (the other end portion in the peripheral direction of the rotation shaft 51, that is, the other end portion in a direction orthogonal to the axial direction of the rotation shaft 51) is set as a free end which is not attached to the casing 48 at the rotational direction downstream side of the rotation shaft 51. Thus, the mylar 90 contacts with the transmitting member 80 due to its elastic force at an appropriate pressure and thus appropriately gives a rotational direction sliding resistance to the transmitting member 80.

The width of the mylar 90 (length in the axial direction of the rotation shaft 51) is set to be substantially the same as the maximum width of the outer peripheral surface of the transmitting member 80 (length in the axial direction of the rotation shaft 51). Therefore, the mylar 90 surface-contacts with the outer peripheral surface of the transmitting member 80 due to its elastic force at an appropriate pressure and appropriately gives a rotational direction sliding resistance to the transmitting member 80.

In the drawings, another mylar 90 (the configuration thereof is preferably the same as that of mylar 90 at the pickup roll 50 side) is also provided between the outer peripheral surface of the transmitting member 70 and the inner surface of the casing 48 at the feeding roll 52 side, but the mylar 90 that gives a sliding resistance in the rotational direction of the transmitting members 70 and 80 may be provided at least between the outer peripheral surface of the transmitting member 80 and the inner surface of the casing 48 at the pickup roll 50 side.

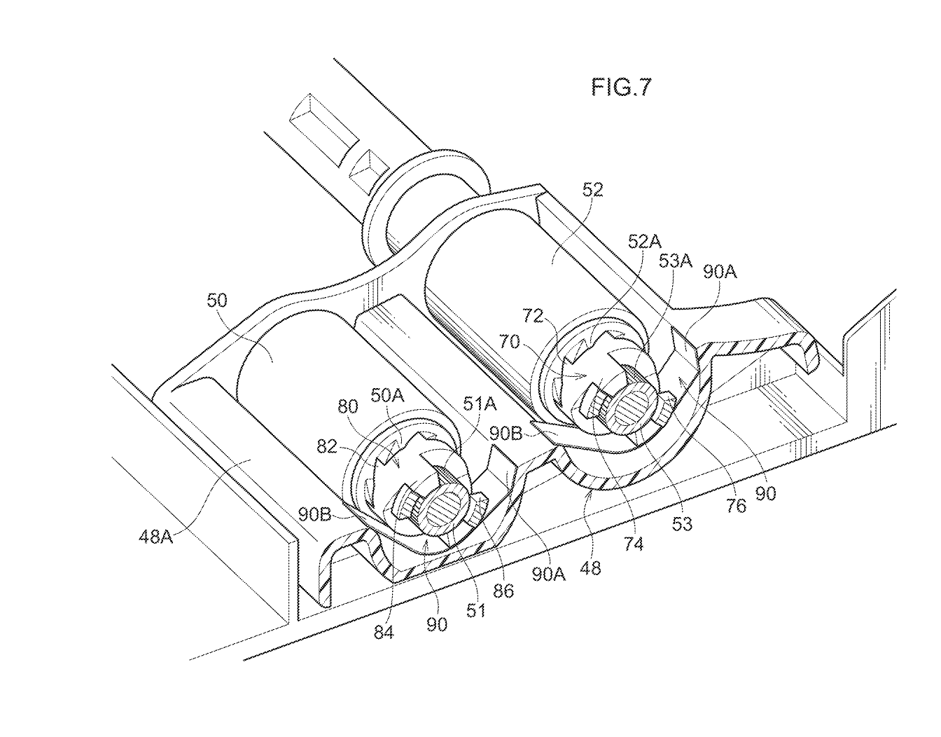

As shown in FIGS. 7 and 8, many groove portions 51A and 53A are formed on the outer peripheral surfaces of the rotation shafts 51 and 53 along their axial directions. Thereby, a contact area between the outer peripheral surface of each rotation shaft 51 and 53 and the inner peripheral surface of each transmitting member 70 and 80 is reduced, so each sliding resistance thereof in the axial direction is reduced, thereby suppressing static electricity from occurring.

Many groove portions (not shown in the drawings) may be formed along the axial direction not on the outer peripheral surfaces of the rotation shafts 51 and 53 but on the inner peripheral surfaces of the transmitting members 70 and 80. If the widths of the groove portions (peripheral direction widths) are set to be different from each other (not to be meshed with each other) at the outer peripheral surfaces and the inner peripheral surfaces, many groove portions may be formed both on the outer peripheral surfaces of the rotation shafts 51 and 53 and on the inner peripheral surfaces of the transmitting members 70 and 80.

The pickup roll 50 is configured to be revolutionable (rotatably movable) relative to the feeding roll 52 so as to take a contacting position (lower position) contacting with the document G on the document accommodating table 42 and a retracting position (upper position) retracting from (being away from) the contacting position.

In other words, the casing 48 that houses the pickup roll 50 while rotatably supporting the pickup roll 50 is supported so as to be rotatably movable in the arrow A direction (see FIG. 2) with the rotation shaft 53 of the feeding roll 52 as a supporting point. A verge (end) portion 48A side (pickup roll 50) at the feeding direction upstream side, where a rotation shaft 51 of the pickup roll 50 is rotatably supported, is always urged toward the retracting position (upward) due to an elastic force of an elastic member 92 (see FIGS. 4 and 5) such as extension helical (coil) spring.

The verge portion 48A of the casing 48 rotates and moves downward against the elastic force (urging force) of the elastic member 92 due to a rotational force to the forward direction (the feeding direction of the document G) of the rotation shaft 53 of the feeding roll 52 rotated to drive by a drive source (not shown in the drawings) thereby to rotate and move the pickup roll 50 which is rotatably supported at the verge portion 48A side toward the contacting position.

When the rotation shaft 53 of the feeding roll 52 reversely rotates, the pickup roll 50 rotates and moves to the retracting position due to the elastic force (urging force) of the elastic member 92. Further, the pickup roll 50 may utilize a force which is independent from the feeding roll 52 to be moved to the contacting position or retracting position.

The operations of the image forming apparatus 10 including the document transporting section 40 having the above structure will be described below. At first, an operator operating the image forming apparatus 10 causes the document accommodating table 42 to accommodate the document G with the read surface on which the image information is recorded faced upward. When the document G is accommodated in the document accommodating table 42, the sensing section senses that the document G is “present.” Then, when the operator operates the operating section 38, the operation of reading the image information of the document G is started.

That is, the rotation shaft 53 of the feeding roll 52 is rotated to drive by the drive source, and the verge portion 48A side of the casing 48 is rotated and moved downward due to the rotational drive force against the urging force of the elastic member about the rotation shaft 52A of the feeding roll 52, and the pickup roll 50 rotates and moves to the contacting position where it contacts with the document G accommodated in the document accommodating table 42 from the retracting position.

On the other hand, the tilted portion 76B in the convex part 76 of the transmitting gear 68 relatively pushes the edge portion 74C of the liner portion 74A in the cam part 74 of the transmitting member 70 due to the relative rotation between the rotation shaft 53 and the transmitting member 70. Then, the edge portion 74C moves along the tilted portion 76B and the transmitting member 70 moves in the axial direction of the rotation shaft 53. After the movement, the linear portion 76A in the convex part 76 and the liner portion 74A in the cam part 74 are maintained to be in a mutually contacting state.

In this way, the edge portion 74C is relatively pushed by the tilted portion 76B, so the transmitting member 70 moved in the axial direction of the rotation shaft 53, that is, moved toward the end surface of the feeding roll 52 (the engaged claw 52A) meshes (engages) the engaging claw 72 with the engaged claw 52A of the feeding roll 52 (that is, the transmitting member 70 is moved to a transmitting position where rotation of the rotation shaft 53 is transmitted to the feeding roll 52 from a releasing position where mesh (engagement) of the engaging claw 72 and the engaged claw 52A is released). Thus, the rotational drive force of the rotation shaft 53 is transmitted to the feeding roll 52 via the transmitting member 70 and the feeding roll 52 is rotated to drive together with the rotation shaft 53.

The rotational drive force is transmitted from the rotation shaft 53 of the feeding roll 52 to the rotation shaft 51 of the pickup roll 50 via the transmitting gear 68, the intermediate gear 78 and the transmitting gear 88. Thus, the tilted portion 86B in the convex part 86 of the transmitting gear 88 relatively pushes the edge portion 84C in the linear portion 84A in the cam part 84 of the transmitting member 80 due to the relative rotation between the rotation shaft 51 and the transmitting member 80 (see FIG. 10A).

Then, the edge portion 84C moves along the tilted portion 86B and the transmitting member 80 moves in the axial direction of the rotation shaft 51. After the movement, the linear portion 86A in the convex part 86 and the liner portion 84A in the cam part 84 are maintained to be in a mutually contacting state.

In this way, the edge portion 84C is relatively pushed by the tilted portion 86B, so the transmitting member 80 moved in the axial direction of the rotation shaft 51, that is, moved toward the end surface of the pickup roll 50 (the engaged claw 50A) meshes (engages) the engaging claw 82 with the engaged claw 50A of the pickup roll 50 (see FIG. 10B) (that is, the transmitting member 80 is moved to a transmitting position where rotation of the rotation shaft 51 is transmitted to the pick up roll 50 from a releasing position where mesh (engagement) of the engaging claw 82 and the engaged claw 50A is released). Thus, the rotational drive force of the rotation shaft 51 is transmitted to the pickup roll 50 via the transmitting member 80 and the pickup roll 50 is rotated to drive together with the rotation shaft 51.

The mylar 90 that gives a rotational direction (peripheral direction) sliding resistance to the transmitting member 80 is provided at least between the outer peripheral surface of the transmitting member 80 and the inner peripheral surface of the casing 48 at the pickup roll 50 side. Therefore, the transmitting member 80 moves in the axial direction of the rotation shaft 51 without not being rotated together with (in interlocking manner) the rotation shaft 51.

In other words, since the transmitting member 80 and the transmitting gear 88 are made of resin material, the transmitting member 80 may be absorbed by the transmitting gear 88 (the rotational direction sliding resistance of the transmitting member 80 is reduced) due to the static electricity being generated by the document G passing near the transmitting member 80, so there may be possibility that the transmitting gear 88 (the rotation shaft 51) and the transmitting member 80 may be rotated together.

However, since the transmitting member 80 is given an appropriate sliding resistance in the rotational direction by the mylar 90, the transmitting gear 88 (the rotation shaft 51) and the transmitting member 80 relatively rotate more ensure than a case in which the mylar 90 is not provided. In other words, due to the cam part 84 engaging with the convex part 86, the transmitting member 80 moves in the axial direction of the rotation shaft 51 to mesh the engaging claw 82 with the engaged claw 50A.

Thus, the rotational drive force of the rotation shaft 51 is transmitted to the pickup roll 50 and thereby a rotational failure will not occur in the pickup roll 50. Therefore, the document G accommodated on the document accommodating table 42 is sent to the feeding roll 52 without failure by the pickup roll 50 which is rotated and moved to the contacting position. In other words, the ability of feeding the documents G accommodated in the document accommodating table 42 is enhanced.

Additionally, since only one longitudinal direction (rotational direction of the rotation shaft) end portion 90A of the mylar 90 is attached to the casing 48 and the other end portion 90B of the mylar 90 is set as the free end, a rotational direction sliding resistance is appropriately given to the transmitting member 80 due to the elastic force of the mylar 90. Further, the width of the mylar 90 is set to be substantially the same as the maximum width of the outer peripheral surface of the transmitting member 80, thus the rotational direction sliding resistance is more appropriately given to the transmitting member 80.

Furthermore, since many groove portions 51A are formed on the outer peripheral surface of the rotation shaft 51, the axial direction sliding resistance of the transmitting member 80 relative to the rotation shaft 51 is reduced so that the static electricity due to the sliding is suppressed from generating. Thus, the transmitting member 80 is surely moved in the axial direction of the rotation shaft 51 without not being rotated together with (in interlocking manner) the transmitting gear 88 (the rotation shaft 51).

Since the mylar 90 is formed to have a film-shape made of PET, a surface resistance is small, and a sliding resistance which is to be given to prevent the transmitting gear 88 (the rotation shaft 51) and the transmitting member 80 from being rotated together with (in interlocking manner) can be finely adjusted. In other words, it is possible that the rotational direction sliding resistance which is to the extent that it does not hinder the axial direction movement of the transmitting member 80 in the rotation shaft 51 can be given to the transmitting member 80.

Therefore, confirming of performance is more easily conducted than a case in which the sliding resistance is not given to the transmitting member 80 by the mylar 90. Since the mylar 90 is formed to have a film shape made of PET and its cost is low, the mylar 90 can be provided between the inner surface of the casing 48 and the outer peripheral surface of the transmitting member 80 without changing the shape design of the casing 48. Thus, an increase in manufacture cost can be restricted.

The document G picked up by the pickup roll 50 from the document accommodating table 42 and fed by the feeding roll 52 is transported by the transporting mechanism 44 in the transporting path 45 and is inverted in its front/back sides by the reversing roll 54, and the image information recoded on the reading surface is read by the document reading section 12.

Then, the document G whose image information recoded on the reading surface is read by the document reading section 12 is discharged from the discharge port 58 by the discharging roll 56 and is discharged (placed) onto the upper surface 46A of the document discharge table 46.

When the image information recorded on the read surface of the document G is read by the document reading section 12, the main body 14 is operated by the controlling section 30 so that an image is formed on a recording sheet P. In other words, the surface of the photoreceptor drum is uniformly charged by the charging roll and a light beam corresponding to an output image is irradiated from the exposing device 20 on the charged surface of the photoreceptor drum so that an electrostatic image is formed.

The developing device gives a toner to the electrostatic image so that a toner image is formed on the photoreceptor drum and the toner image is transferred onto the recording sheet P by the transfer roll. Thereafter, the recording sheet P is sent to the fixing device 26 and the toner image is fixed. Then, the recording sheet P on which the toner image is fixed is discharged from the discharge port 32 onto the cover member 28.

The document transporting device (the document transporting part 40) and the image forming apparatus 10 according to the present exemplary embodiment are described with reference to the example shown in the drawings, but the document transporting device and the image forming apparatus 10 according to the present exemplary embodiment are not limited to the illustrated example. For example, a resistor is not limited to the mylar 90 and whatever may appropriately give a rotational direction sliding resistance to the transmitting member 80 may be used. For example, foam body (sponge) may be used. Further, the document transporting device according to the present exemplary embodiment may be applied to a so-called scanner or facsimile.

1. A document transporting device comprising:
a document accommodating section in which a document is accommodated;
a transporting mechanism that transports the document accommodated in the document accommodating section along a transporting path;
a feeding member that contacts with the document accommodated in the document accommodating section and feeds the document to the transporting mechanism by rotating;
a rotation shaft that is driven to rotate and that rotatably supports the feeding member;
an engaged portion that is formed at an end portion of the feeding member;
a transmitting member that, by moving in an axial direction of the rotation shaft, can be located at a transmitting position where rotation of the rotation shaft is transmitted to the feeding member by an engaging portion of the transmitting member being engaged with the engaged portion, and at a releasing position where engagement between the engaged portion and the engaging portion is released;
a moving member provided on the rotation shaft, that, upon relative rotating of the rotation shaft and the transmitting member, moves the transmitting member to the transmitting position and transmits the rotation of the rotation shaft to the transmitting member; and
a resistor that contacts with an outer peripheral surface of the transmitting member and provides a resistance in a rotational direction to the transmitting member.

2. The document transporting device of claim 1, wherein a length of the resistor in the axial direction of the rotation shaft, is substantially the same as a length of the transmitting member in the axial direction of the rotation shaft.

3. The document transporting device of claim 1, further comprising a case that rotatably supports the rotation shaft and accommodates the feeding member in a state in which an outer peripheral surface of the feeding member is exposed,
wherein one end portion of the resistor, in a peripheral direction of the rotation shaft, is attached to the case at an upstream side in a rotational direction of the rotation shaft, and the other end portion of the resistor, in the peripheral direction of the rotation shaft, is configured as a free end.

4. The document transporting device of claim 1, wherein a plurality of groove portions are formed along the axial direction of the rotation shaft on at least one of an outer peripheral surface of the rotation shaft and an inner peripheral surface of the transmitting member.

5. The document transporting device of claim 3, wherein the one end portion of the resistor is attached to an opening edge portion of the case at the upstream side in the rotational direction of the rotation shaft, and the other end portion of the resistor configured as the free end is at a downstream side in the rotational direction of the rotation shaft.

6. The document transporting device of claim 1, wherein:
a tilted portion that is tilted relative to the axial direction of the rotation shaft is formed at the moving member, and
the moving member moves the transmitting member to the transmitting position by the tilted portion pushing the transmitting member due to rotation of the moving member caused by rotation of the rotation shaft.

7. An image forming apparatus comprising:
a document transporting device including:
a document accommodating section in which a document is accommodated;
a transporting mechanism that transports the document accommodated in the document accommodating section along a transporting path;
a feeding member that contacts with the document accommodated in the document accommodating section and feeds the document to the transporting mechanism by rotating;
a rotation shaft that is driven to rotate and that rotatably supports the feeding member;
an engaged portion that is formed at an end portion of the feeding member;
a transmitting member that, by moving in an axial direction of the rotation shaft, can be located at a transmitting position where rotation of the rotation shaft is transmitted to the feeding member by an engaging portion of the transmitting member being engaged with the engaged portion, and at a releasing position where engagement between the engaged portion and the engaging portion is released;
a moving member provided on the rotation shaft, that, upon relative rotating of the rotation shaft and the transmitting member, moves the transmitting member to the transmitting position and transmits the rotation of the rotation shaft to the transmitting member; and
a resistor that contacts with an outer peripheral surface of the transmitting member and provides a resistance in a rotational direction to the transmitting member;
a document reading section that reads image information of the document transported by the transporting mechanism of the document transporting device; and
an image forming section that forms an image on a recording medium based on the image information read by the document reading section.

8. The image forming apparatus of claim 7, wherein a length of the resistor in the axial direction of the rotation shaft, is substantially the same as a length of the transmitting member in the axial direction of the rotation shaft.

9. The image forming apparatus of claim 7, further comprising a case that rotatably supports the rotation shaft and accommodates the feeding member in a state in which an outer peripheral surface of the feeding member is exposed,
wherein one end portion of the resistor, in a peripheral direction of the rotation shaft, is attached to the case at an upstream side in a rotational direction of the rotation shaft, and the other end portion of the resistor, in the peripheral direction of the rotation shaft, is configured as a free end.

10. The image forming apparatus of claim 7, wherein a plurality of groove portions are formed along the axial direction of the rotation shaft on at least one of an outer peripheral surface of the rotation shaft and an inner peripheral surface of the transmitting member.

11. The image forming apparatus of claim 9, wherein the one end portion of the resistor is attached to an opening edge portion of the case at the upstream side in the rotational direction of the rotation shaft, and the other end portion of the resistor configured as the free end is at a downstream side in the rotational direction of the rotation shaft.

12. The image forming apparatus of claim 7, wherein:
a tilted portion that is tilted relative to the axial direction of the rotation shaft is formed at the moving member, and
the moving member moves the transmitting member to the transmitting position by the tilted portion pushing the transmitting member due to rotation of the moving member caused by rotation of the rotation shaft.
